(19) United States
(12) Patent Application Publication
(10) Pub. No.: US 2010/0050848 A1
(43) Pub. Date: Mar. 4, 2010

(54) METHOD FOR OPERATING A BOARD PARTITIONING SYSTEM FOR LARGE-FORMAT BOARDS AND BOARD PARTITIONING SYSTEM FOR LARGE-FORMAT BOARDS

(75) Inventor: Uwe Elhaus, Calw (DE)

Correspondence Address: Brinks Hofer Gilson & Lione/Ann Arbor, 524 South Main Street, Suite 200, Ann Arbor, MI, 48104, US

(73) Assignee: Holzma Plattenaufteiltechnik GmgH, Calw-Holzbronn (DE)

(21) Appl. No.: 12/613,253

(22) Filed: Nov. 5, 2009

Related U.S. Application Data
(63) Continuation of application No. PCT/EP2007/004042, filed on May 8, 2008.

(51) Int. Cl. B26D 5/06; B26D 5/20; B23Q 15/00

(52) U.S. Cl. 83/863; 83/471.1; 83/74

(57) ABSTRACT

The disclosure relates to a method for adjusting a scoring blade for a board partitioning system for large-format board including the following steps: a. sawing a groove in the board using a saw blade, detecting the sawed groove using a detection device, storing the data; b. displacing the board a feed distance using a feeding device; c. scoring a groove parallel to the sawed groove but at a distance there from, detecting the scored groove using the same detection device as in step a); d. comparing the position of the scored groove and the position of the sawed groove relative to a common reference fixed to the detection device; e. if required: correcting the position of the scoring blade and/or the saw blade orthogonally to the board plane such that the center axes of the scored groove and the sawed groove are approximately equal relative to the common reference fixed to the detection device.

### CROSS-REFERENCE TO RELATED APPLICATIONS

This application is a continuation of International Application No. PCT/EP2007/004042 filed on May 8, 2007. The disclosure of the above application is incorporated herein by reference.

### FIELD

The disclosure relates to a method of operating a panel-sizing system for large-format panels, particularly for the manufacture of furniture.

### BACKGROUND

The statements in this section merely provide background information related to the present disclosure and may not constitute prior art.

From the market, panel-sizing systems are known that have a saw with a sawing blade and a scorer with a scoring blade. By means of such a scorer, a scored groove is made in the region of the surface of a panel-shaped workpiece; but said groove does not sever the workpiece. The actual severing process is carried out by the saw and its saw blade. The width of the scored groove is normally equal to the width of the sawed joint that is produced by the saw, or it is somewhat larger (maximally 0.1 mm) than the width of the sawed joint. Using the scorer prevents the workpiece surface from being torn during the actual severing operation that is performed by the saw. This applies particularly in the case of workpieces with a surface coating. Scorers are also known that have a conical scoring blade, with which the width of the scoring groove is set by means of its depth.

When producing the scored groove, it is important that this is aligned as exactly as possible with the subsequently introduced sawed joint. It is therefore proposed in DE 195 20 108 A1, that at the start of a sawing process, the saw blade of the saw and the scoring blade of the scorer be measured using sensors, and that the position of the scoring blade relative to the sawing blade be set independently of the measuring result. However, this known device has the disadvantage of being very complex, as well as the disadvantage that the work result, the alignment of the scored groove and the sawed joint, is often not guaranteed.

### SUMMARY

We disclose a method by which the alignment between the scored groove and the sawed joint can be set simply and precisely. We also disclose a system to create a corresponding panel-sizing system.

Features of the disclosure are also shown in the subsequent description and the drawing, whereby these features, by themselves or in various combinations, may be integral to the disclosure, even if that is not explicitly pointed out in individual cases.

A method of operating a panel-sizing system for large-format panels is disclosed in which a sawed joint is produced by the movement of a saw carriage along a cutting line, whereby during this movement, a scorer with a scoring blade first makes a scored groove in an underside of the panel, and during this movement a saw blade that is arranged, viewed in the direction of sawing, behind the scorer blade and located at least essentially in the plane of the scoring blade, produces the sawed joint, and during which the panel or the stack of panels lies on a supporting table and is moved diagonally to the cutting line for successive sizing by a feed device, characterized in that the method may also includes the following steps:
a. The making of a sawed joint or joint in the panel by means of the saw blade, detection of the sawed joint or joint using an electronic detection device, storage of the recorded data;
b. The moving of the panels by means of the feed device by a prescribed feed distance;
c. The making of a scored groove in the panel, said groove being parallel to the sawed joint or joint, by means of the scoring blade, detection of the scored groove using the same electronic detection device as in Step a;
d. Comparing of the position of the scored groove and the position of the sawed joint or joint in relation to a common reference that is fixed for the detection device;
e. If necessary, correction of the position of the scoring blade and/or the sawing blade orthogonally to the blade plane, so that the center axes or the scored groove and the sawed joint lie more or less identically compared to the common reference that is fixed for the detection device.

A panel-sizing system for large-format panels is disclosed. The system may include, for example, a supporting table; a saw carriage that can be moved along a cutting line, the carriage having has a saw blade and scoring blade that is arranged at least approximately in the plane of the saw blade; with a feed device for displacing a panel/panels that lie on the supporting table; and with an adjusting device by means of which the position of the scoring blade can be adjusted orthogonally to the blade level; characterized in that it includes a detection device for detecting the work result of scoring blade and saw blade and a control and/or regulating device that are programmed for use in a method according to the principals of the disclosure.

With the disclosed method and the disclosed panel-sizing system, a costly gauging of the saw blade or the scoring blade is dispensed with. Instead, if deemed necessary, a special adjustment method is simply used. When using this method, as a first step, a sawed joint is made in the underside of a panel. The saw blade is thus adjusted in such a way that it does not sever the workpiece. Or a sawed joint is made in the workpiece, which severs the workpiece at least regionally. For this purpose, the saw blade is set into rotation, and the saw carriage, on which the saw blade and the scoring blade are arranged one after the other, is displaced. For example, when the saw carriage is displaced, or immediately thereafter, the position of the sawed joint, or as the case may be joint, is detected by an electronic detection device. The saw blade is lowered again, the panel is moved forward one feed distance, and then, during another movement of the saw carriage, a scored groove is made on the underside of the workpiece. After the scored groove is made, its position is detected once again by the same detection device. The detected positions are then compared relative to a common reference, and if needed, if an unallowable deviation is detected (greater than a limit value), the position of the scoring blade and/or the saw blade diagonally to the panel level is corrected so that they are aligned as precisely as possible.

This adjustment process can, for example, be carried out each time the saw blade or the scoring blade is replaced. It is immaterial whether the sawed joint or the scored groove is made first on the underside of the panel. In addition, it should be pointed out at this juncture that the method can be used when there is a single panel lying on the supporting table, or when an entire stack of panels is lying on the supporting table. Regarding the panel used for the proposed method, it can be a panel that is specifically intended for this process, for example a surplus panel from a previous panel-sizing process, or it can be a panel intended for a subsequent partitioning process.

With a first advantageous further development of the method according to the principles disclosed, it is proposed that the method include the following steps:

f. Comparison of the width of the scored groove and the width of the saw groove

g. If required, correction of the width of the scored groove, so that a bilateral overhang of the scored groove beyond the sawed joint has at least an approximately desired value.

In this way, particularly high cut-quality is achieved, provided that the scoring blade is conical, so that a width adjustment is at all possible.

It is also proposed that the electronic detection device at least intermittently provide an image of the sawed joint or joint and the scored groove. For this purpose, the detection device can include a reasonably priced monitor, on which the scored groove and the sawed joint or joint can be visualized. In this way, a user of the method can very quickly check the quality of the proposed adjustment method.

Steps a to d, or as the case may be f and g, may take place automatically. This increases the precision of the adjustment and shortens the time required for it. The corresponding panel-sizing system may have a remote-controlled adjusting device for adjusting the scoring blade vertically to its plane, and the control and regulation device may control the adjusting device and may therefore automatically correct the position of the scoring blade.

With a fully automated process and a means of visualization, if inconsistent values are detected for the position and/or shape of the sawed joint and joint and/or the scored groove during fully automatic execution of the method, the electronic detection device can simultaneously present the sawed joint or joint and the scored groove, together with the detected positions and/or geometries, so that the user can manually adjust the detected position and/or geometry to the actual position(s) and/or shape/shapes, after which the correction is once again automatically carried out according to Steps e and g. In this way, it is taken into account that when detecting the position and/or shape of the grooves, or of the joints introduced, there inaccuracies can occasionally arise, which can be very quickly eliminated in the proposed manner.

An additional refinement of the method according to the disclosed principles provides for the sawed joint or joint to be made during a backward movement of the saw carriage. This ensures that the saw teeth of the saw blade cut from the outside into the material and do not, as in the case of forward movement, cut from inside the material outward. With this procedure, making the sawed joint or joint causes less tearing, which also improves the precision of the adjustment method.

Steps b through d or f can be repeated after step e or else after g to monitor the correction implemented, owing to which the precision of the adjustment process is likewise increased.

The detection device can be moved together with the saw blade and the scoring blade, for example by arranging the detection device first, then the scoring blade, and then the saw blade on the saw carriage in the direction of sawing. This is particularly cost-efficient. However, the detection device can also be arranged on its own movable carriage, for example, it can be kept in a lateral, resting position during normal sawing operation and therefore be less contaminated.

In the case of an additional variation of the disclosed method, it is proposed that a sawed joint be made using the saw blade, that the sawed joint be detected by the detection device, and that the quality of the sawed joint, in particular the size and/or number of tears and/or amplitude and frequency of a boundary wave, be assessed.

In this way, quality control of the split lines produced during normal sawing operation is made possible, so that there can be timely notification, for example, of a dulling of the sawing blade or the scoring blade due to wear, or the necessity of another adjustment of the alignment between sawing blade and scoring blade.

As camera can, for example, be used as a detection device, which can visualize the scored groove and the sawed joint in a particularly simple manner on a screen. However, a laser scanning device or an ultrasound scanning devices is also possible as a detection device.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1: is a lateral view of a panel-sizing system with a saw carriage;

FIG. 2: is a cut along the line II-II from FIG. 1;

FIG. 3: is a perspective representation of a workpiece and a saw carriage from FIG. 2 with a first procedural step of a method for adjusting a scoring blade to align with a sawing blade;

FIG. 4: is a representation similar to FIG. 3 in connection with a second procedural step;

FIG. 5: is a representation similar to FIG. 3 in connection with a third procedural step;

FIG. 6: is a representation similar to FIG. 3 in connection with a fourth procedural step;

FIG. 7: is a representation similar to FIG. 3 in connection with a fifth procedural step;

FIG. 8: is a representation similar to FIG. 3 in connection with a sixth procedural step;

FIG. 9: a first view of a monitor of the panel-sizing system before the procedural step in FIG. 7;

FIG. 10: a second view of a monitor after completion of the adjustment procedure;

FIG. 11: a top view upon a workpiece with outliers; and

FIG. 12: is a section along the line XII-XII of FIG. 11.

The drawings described herein are for illustration purposes only and are not intended to limit the scope of the present disclosure in any way.

### DETAILED DESCRIPTION

The following description is merely exemplary in nature and is not intended to limit the present disclosure, application, or uses.

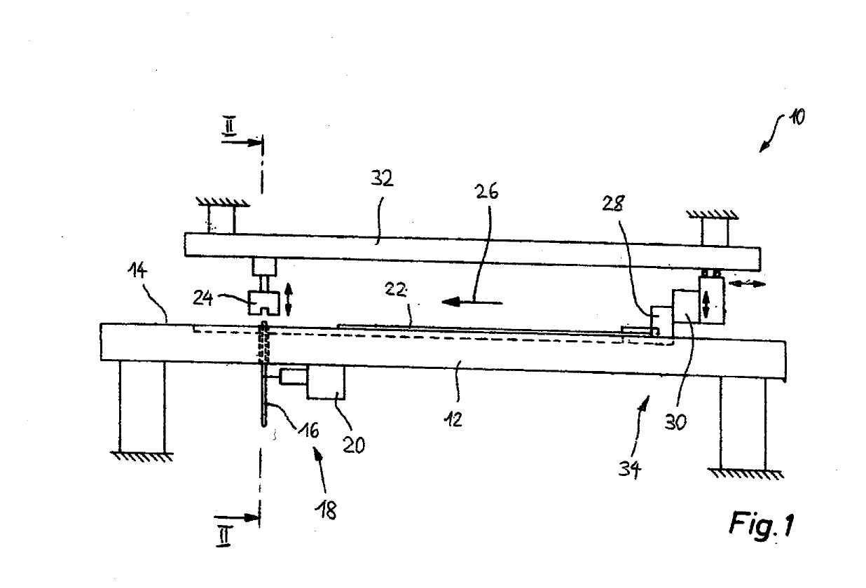

In FIG. 1, a panel-sizing system for large-sized panels has the reference sign 10 overall. It may include a horizontal supporting table 12 with an upper supporting surface 14, which is also horizontal. A saw blade 16 of a saw 18 is arranged on a saw carriage 20 that is vertically displaceable relative to the drawing plane of FIG. 1. With this saw 18, a large-format panel 22 that is lying on the supporting surface 14 can be partitioned into smaller single panels or panel strips of the kind used, for example, in the production of furniture parts. Only a single panel 22 is shown in FIG. 1, however it is understood that the following explanations also apply when an entire stack of panels is lying on the supporting table 12 instead of this one panel. In order to hold the panel 22 securely in position during the sawing operation, a clamping bar 24 that can be lowered vertically is provided above the saw 18.

In order to divide the panel 22 into single strips, it is necessary to move the panel 22 in the feed direction (arrow 26). For this purpose, a plurality of gripping mechanisms in the form of collets are arranged in one direction parallel to the drawing plane, of which only one is visible in FIG. 1 with the reference sign 28. The collets 28 are displaceably held on a position shifter 30 that extends vertically to the plane of the drawing. The latter can, in turn, be moved along two horizontal tracks, only one of which, with the reference sign 32, is visible in FIG. 1, located longitudinally to the feed direction 26. Together, the collet 28, the position shifter 30 and the tracks 32, form a feed device 34.

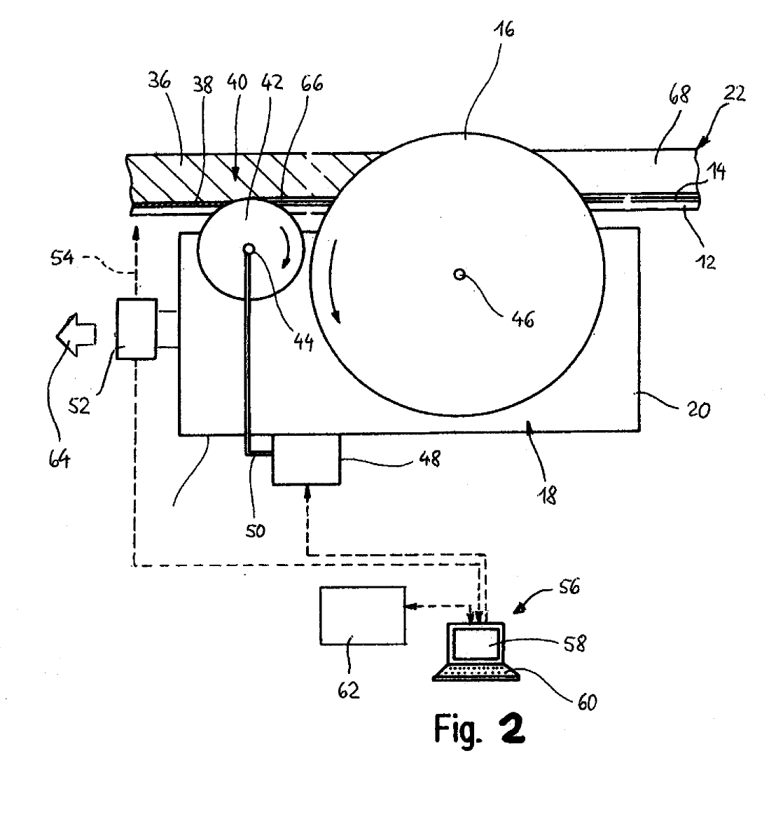

Now the structural assembly of the saw carriage 20 will be explained in detail with reference to FIG. 2. First, it is seen that the panel 22 has a pressboard core 36 and a surface coating 38, on which lies on the supporting surface 14 of the supporting table 12.

A scorer 40 with a conical scoring blade 42 is affixed to the saw carriage 20, in addition to the saw 18 with the saw blade 16. The scoring blade 42 is driven around an axis 44, the saw blade 16 around an axis 46. In the FIGS. 1 and 2, the saw carriage 20 is displaceable diagonally to the feed direction 26 in a manner that is not described in more detail; in FIG. 1, therefore, vertically to the drawing plane.

On the saw carriage 20, there is an electric adjusting device 48, by means of which, as indicated by a double line 50, the scoring blade 42 can be displaced orthogonally in relation to its blade plane, and therefore also vertically toward the blade plane of FIG. 2, and with which (as is not shown in more detail), the depth of immersion of the scoring blade 42 can be adjusted. In addition, a video camera 52 belonging to a detection device and oriented toward the underside (without reference number) of the panel 22 is affixed to the saw carriage 20, as indicated by a sighting arrow 54. Instead of a video camera, a laser scanning device or an ultrasound scanning device could be used.

The video camera 52 transmits corresponding signals to a control and regulating device 56, for example a computer, which also includes a monitor 58 and an input device 60. The control and regulating device 56 is also connected to an evaluation system 62, whose function will be explained in more detail below. The electric adjusting device 48 is controlled by the control and regulating device 56, as are the drive assemblies, which are not shown, and which cause the saw blade 16 and the scoring blade 42 to rotate.

During normal operation of the panel-sizing system 10, the saw carriage 20 moves along a cutting line in the direction of cutting which is indicated by the arrow 64 in FIG. 2. Seen in the cutting direction 64, the video camera 52 is arranged first on the saw carriage 20, followed by the scorer 40 and the saw 18. In a variation that is not shown, the video camera is not deposed on the same saw carriage as the saw and the scorer, but rather on a separate, movable carriage.

Due to the arrangement of saw 18 and scorer 40 on the saw carriage 20, the scorer blade 42 first cuts a scored groove 66 in the underside of the panel 22 when the saw carriage 20 moves in the cutting direction 64. The depth of this scored groove 66 is somewhat greater than the thickness of the surface coating 38 of the panel 22 and depends, due to the conicity of the scoring blade 42, on the depth of immersion in the panel 22. Then the saw blade 16 of the saw 18 cuts the actual split line 68 in the panel 22, by means of which the panel 22 is partitioned into two separate pieces. After this dividing or severing cut, the panel 22 of the feed device 34 is displaced a desired distance in the feed direction 26, so that the next cut can follow. In this way, the panel 22 is successively partitioned.

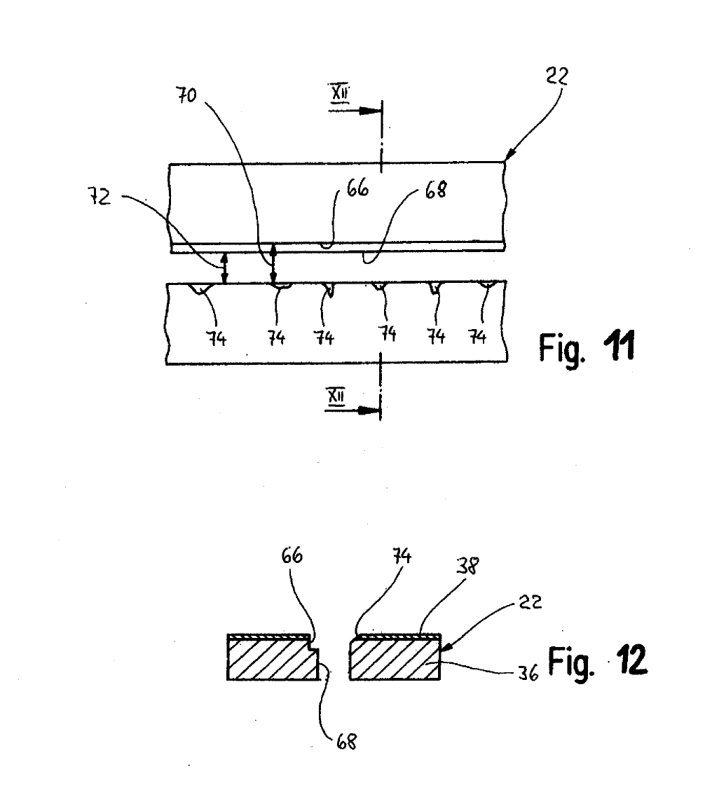

As the FIGS. 11 and 12 show, the scored groove 66 is usually somewhat wider (width 70) than the sawed joint 68 (width 72). The center axes of the scored groove 66 and the sawed joint 68 should approximately align, so that the overhang of the scored groove 66 beyond the sawed joint 68 is approximately equal on both sides. Using this procedure avoids damaging the surface coating 38 and creating the so-called “outliers” that are referred to with 74 in the FIGS. 11 and 12 when making the sawed joint 68. The reason for the outliers 74 shown in the FIGS. 11 and 12 is the fact that here, the scored groove 66 and the sawed joint 68 do not align sufficiently well.

In order to prevent formation of the said outliers 74, as noted above, the scored groove 66 and the sawed joint 68 align with each other, and that on either side of the scored groove 66, there is a certain overhang compared to the sawed joint 68. However, as normal scoring blades 42 have tolerances, the scoring blade 42, after a change of tool for example, must be readjusted relative to the saw blade 16 in a direction vertical to the blade plane of FIG. 2 in such a way that the scored groove 66 once again aligns with the sawed joint 68. For this purpose, an adjustment procedure is carried out in the plate partitioning system 10, the basis for which is an image of the panel 22 taken by the video camera 52, and which is therefore the result of the operation of the saw blade 16 and the scoring blade 42.

This adjustment procedure is stored as a computer program in a memory of the control and regulating device 56. The adjustment procedure is not carried out during the normal operation of the panel-sizing system 10, i.e. when panels are actually supposed to be partitioned, but rather as a separate procedure, for example after replacing the scoring blade 42. In such cases, it is self evident that the adjustment procedure described below can be carried out on both a “test panel,” which is available in the form of cutting scrap, and a piece of a panel 22 that is intended for subsequent partitioning.

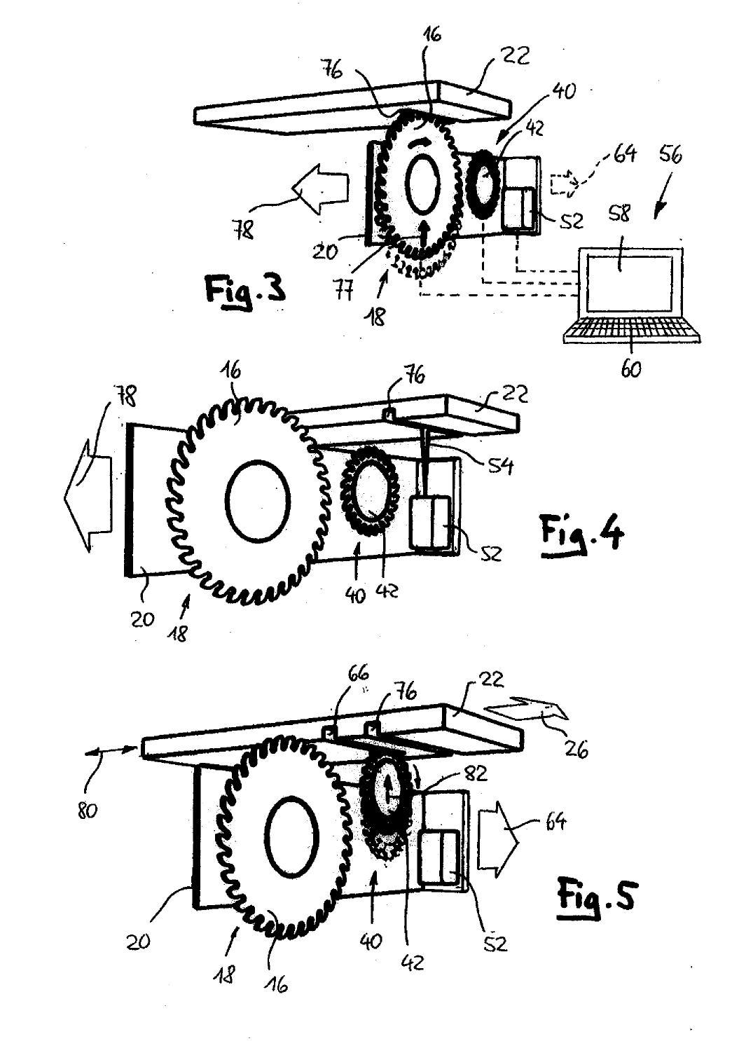

FIG. 3 shows that with the cited adjustment procedure, a sawed groove 76 is first made in the underside of the panel 22 using the saw blade 16.

The use of the term “sawed groove” includes, for example, that the saw blade 16 is adjusted in such a way that the panel 22 is not completely severed. The present adjusting procedure could also be used when, in this step, a sawed joint is made by the sawing blade 16, instead of a sawed groove.

The sawed groove 76 is made by first raising the saw blade 16, corresponding to the arrow 77, from its resting position, shown in FIG. 3 with a dashed line, and making it rotate, and then moving the saw carriage 20 in reverse direction 78, i.e. counter to the sawing direction 64. With this kind of reverse movement, the saw teeth of the saw blade 16 cut into the material of the panel 22 and do not, as in the case of forward movement in the sawing direction 64, cut from inside the panel 22 material outward. This has the advantage of creating fewer outliers when making the sawed groove 76.

As FIG. 4 shows, the sawed groove 76 that is created is then detected by the video camera 52, and its position is evaluated in relation to the axis of sight 54. The axis of sight 54 is a fixed reference for the detection device, or as the case may be the video camera 52, to which the detected values are compared. The detected values are stored in a memory of the control and regulating device 56, as is the image of the sawed groove 76 that is recorded by the video camera 52.

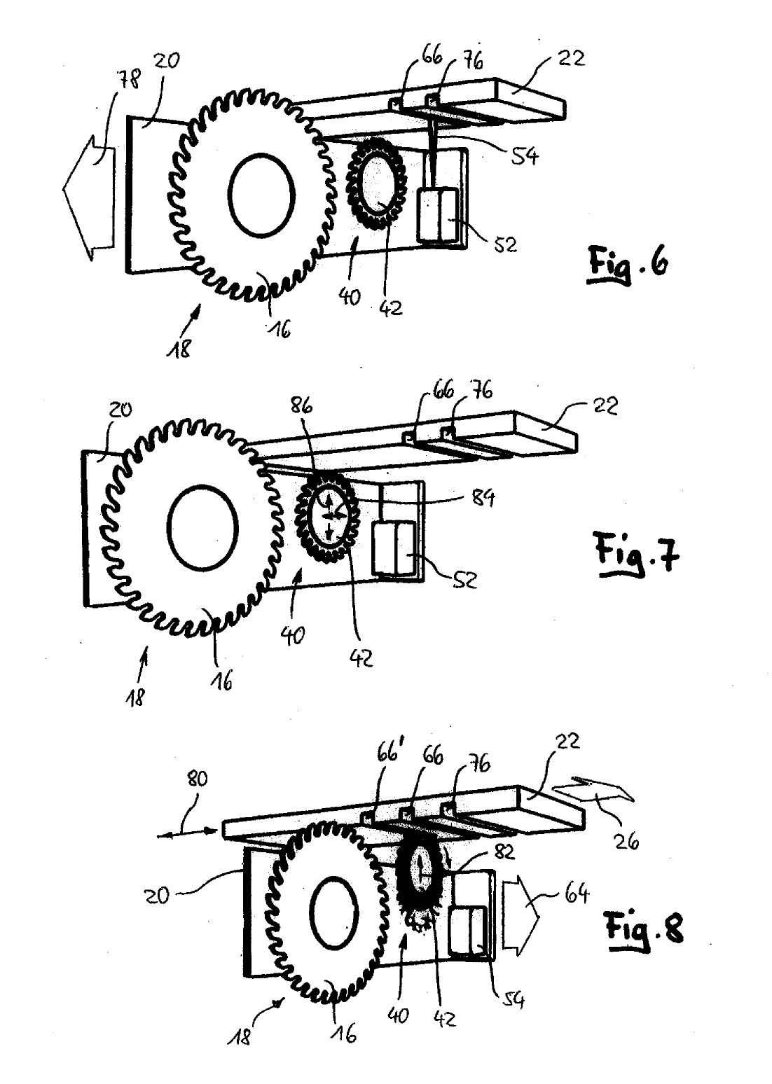

In the next step, which is shown in FIG. 5, the panel 22 is moved by the feed device 34 a prescribed feed distance D in the feed direction 26. Then the saw carrier 20 is moved in the sawing direction 64, and using the scoring blade 42, a scored groove 66 is made in the underside of the panel 22. The scored groove 66 is thus parallel to the sawed groove 76, however at a distance from it. In order to produce the scored groove 66, the scoring blade 42 is moved from a resting position indicated in FIG. 5 by a dashed line into the operating position (Arrow 82), made to rotate, and the saw carriage 20 is moved in the sawing direction 64. Now, as can be seen in FIG. 6, the saw carriage 20 is moved in the reverse direction 78, and as this happens, the video camera 52 detects the scored groove 66 that has been made and assesses its position relative to the axis of sight 54 of the video camera 52 and assesses its width.

The control and regulating device 56 now compares the position of the scored groove 66 with the position of the sawed groove 76, in each case compared to the axis of sight 54. When the deviation in the position, for example of the center axis of the scored groove 66 from the corresponding position of the sawed groove 76 reaches a limit value or exceeds it, a correction value for the position of the scoring blade 42 is calculated from this comparison, and on that basis, the position of the scoring blade 42 diagonal to its blade plane is corrected by means of directing the adjustment direction 48 in such a way that the center axes of the scored groove 66, on the one hand, and the sawed groove 76 on the other, in relation to the common reference that is fixed for the detection direction 52, i.e. the axis of sight 54, are approximately the same. Or, for example, the correction is made by making the overhang of the scored groove 66 beyond the sawed groove 76 approximately the same on both sides of the sawed groove 76. This adjustment of the scoring blade 42 is indicated in FIG. 7 by a horizontal double arrow 84 that is also orthogonal to the plane of the scoring blade 42. The comparison with a limit value described above may, however be omitted, and only a correction made instead.

However, the video camera 52 not only detects the position of the sawed groove 76 and the scored groove 66 compared to the fixed reference 54, but also their width. The width 70 (FIG. 11) of the scored groove 70 is compared to the width 72 of the sawed groove 76, and is then, for example, only when the deviation of the detected width from a desired width reaches a limit value or exceeds it, a correction value is given such that a prescribed overhang of the scored groove 66 on either side of the sawed groove 76 is achieved. Because the scoring blade 42 is conical, as stated at the beginning, the width of the scored groove 70 can be adjusted by means of the depth of immersion of the scoring blade 42 in the panel 22. This correction of the immersion depth is indicated in FIG. 7 by means of a vertical double arrow 86.

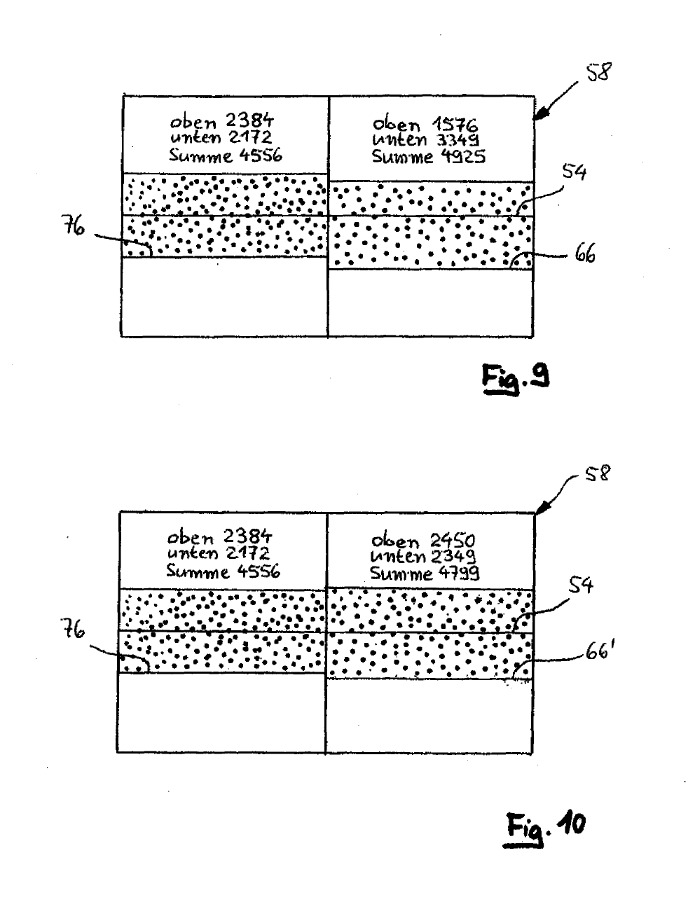

In order to check the correction made, as seen in FIG. 8, the panel 22 is once again moved the feed distance 80 in the feed direction 26, the scoring blade 42 is once again lifted out of its resting position in the direction of the arrow 82 and into its working position and made to rotate, and the saw carriage 20 is moved in the sawing direction 64. In this way, a second scored groove 66′ is created, which, as described above in connection with FIG. 6, is then detected by the video camera 52 and its position relative to the axis of sight 54 of the video camera 52 assessed. Depending on the result, another correction of the position of the scoring blade 42 according to FIG. 7 might be carried out, or an error message might be sent if a correction does not appear possible.

The image that the user of the panel-sizing system 10 sees on the monitor 58 is shown in FIGS. 9 and 10: the image according to FIG. 9 appears after the procedural step according to FIG. 6, before the position of the scoring blade 42 is corrected. The visual axis 54 that serves as a fixed reference is shown on the monitor as a horizontal line. In the left half of the monitor 58, the sawed groove 76 is shown, which compared to the rest of the underside of the plate 22 looks comparatively dark, which is indicated by a dotted representation in FIGS. 9 and 10. The left side in FIG. 9 is therefore the picture that is taken by the video camera 52 according to the procedural step in FIG. 4.

In the right half of the monitor 58 according to FIG. 9, the scored groove 66 is shown, as it is detected by the video camera 52 in the procedural step shown in FIG. 6. In both halves, the detected positions of the boundary lines of the sawed groove 76, or as the case may be the scored groove 66, are shown numerically (in micrometers) relative to the axis of sight 54, and the sum of the two distances of the edges from the axis of sight 54 is also given in each case. At this point, it should be expressly stated once again that the two images shown on the monitor 58 are recorded at different points in time and at different sites, however with the same video camera 52, and that this is the reason the shape that is visible in these two images can still be compared to the same reference, i.e. the axis of vision 54.

It is apparent from the visualization in FIG. 9 that the scored groove 66 shown on the right side is displaced downward compared to the sawed groove 76. It therefore does not align in the desired manner with the sawed groove 76. What is more, the scored groove 66 should have a width of approximately 4800 μm, whereas in the state shown in FIG. 9, it has a width of approximately 4925 μm, which even with an adjustment of the scored groove 66 to the sawed groove 76, would still result in an undesirable overhang value.

By means of the correction of the orthogonal position of the scorer blade 42 with respect to the blade plane (double arrow 84) and by means of the correction of the depth of immersion (double arrow 86) described in connection with FIG. 7, the position of the scorer groove 66′ is corrected as can be seen in FIG. 10, on the one hand, in such a way that it is now at least approximately flush with the saw groove 76 concerning the same reference of the visor axis 54. The width was also corrected in such a way that the scorer groove 66′ has now a width of 4799 μm, which leads at least approximately to the desired residues on both sides of the sawing groove 76.

The operation described in FIGS. 3 to 8 may take place fully automatically, controlled by the control and regulating device 56. The representations according to FIGS. 9 and 10 may only appear on the monitor 58 when non-conclusive figures are obtained from automatic detection of the position and geometry of the sawed groove 76 and the scored groove 66 using conventional image recognition processes. By means of the visualization that appears on the monitor in this case 58, the user can decide whether he will use the representation according to FIG. 9 for a manual, or as the case may be semi-manual adjustment. If necessary, the user can correct the recording of the edges of the scored groove 66 and the sawed groove 76 that is automatically detected, in the sense of image recognition, by the control and regulating device 56, for example, by moving the edge that is detected by the control and regulating device 56 onto the actual edge that is shown in the image. The subsequent adjustment corresponding to FIG. 7 is then conducted again automatically, but with reference to the images corrected by the user.

An evaluation system is also integrated into the control and regulating device 56, said evaluation system assessing or as the case may be verifying the quality of the scored groove 66 and the sawed groove 76 on the basis of the images that the video camera 52 provides of them. In particular, this kind of evaluation system can assess the size and/or number of outliers 74 (see FIGS. 11 and 12) and/or the amplitude and frequency of a boundary wave. Here too, a precondition may be that the outlier, or as the case may be the boundary wave, is detected by the detection device, for example the video camera 52, and is recognized in the context of image recognition by the control and regulating device 56.

It should be noted that the disclosure is not limited to the variations described and illustrated as examples. A large variety of modifications have been described and more are part of the principles of the disclosure. These and further modifications as well as any replacement by technical equivalents may be added to the description and figures, without leaving the scope of the protection of the disclosure and of the present patent.

What is claimed is:

1. A method of operating a panel-sizing system for large-format panels, in which a sawed joint is produced by the movement of a saw carriage along a cutting line, whereby during this movement, a scorer with a scoring blade first makes a scored groove in an underside of at least one panel, and during this movement a saw blade that is arranged, viewed in the direction of sawing, behind the scorer blade and located at least essentially in the plane of the scoring blade, produces the sawed joint, and during which the panel lies on a supporting table and is moved diagonally to the cutting line for successive sizing by a feed device, characterized in that the method comprises at least one of the following steps:
a. making a joint in the panel by means of the saw blade, detecting the joint using an electronic detection device, storing the recorded data;
b. moving the panel by means of the feed device by a prescribed feed distance;
c. making a scored groove in the panel, said groove being parallel to the joint, by means of the scoring blade, detecting the scored groove using the same electronic detection device as in Step a;
d. Comparing the position of the scored groove and the position of the joint in relation to a common reference that is fixed for the detection device; and
e. correcting the position of at least one of the scoring blade and the sawing blade orthogonally to the blade plane, so that the center axes or the scored groove and the sawed joint lie approximately identically compared to the common reference that is fixed for the detection device.

2. The method according to claim 1, characterized in that it also comprises at least one of the following steps:
f. Comparing the width of the scored groove and the width of the sawed joint or joint; and
g. Correcting the width of the scored groove so that an overhang on both sides of the scored groove beyond the sawed joint has at least approximately the desired value.

3. The method according to one of the claim 1, characterized in that the electronic detection device, provides an image of at least one of the sawed joint, joint and the scored groove.

4. The method according to claim 1, characterized in that the Steps a to take place automatically.

5. The method of claim 2, characterized in that the Steps a to g take place
automatically.

6. The method according to claim 3, characterized in that when inconsistent values are identified for at least one of the position and geometry of an identifier comprising at least one of the sawed joint, joint, and the scored groove during fully automatic implementation of the process, the electronic detection device simultaneously represents the at least one of sawed joint or joint and the scored groove together with the at least one of detected positions and/or geometries, so that the user can manually adjust at least one of the detection position and/or geometry to at least one of the actual positions and geometries, at which point the correction can be carried out fully automatically according to the Steps e and g.

7. The method according to claim 1, characterized in that the sawed joint or joint is made during Step a, during a reverse movement of the saw carriage.

8. The method according to claim 1, characterized in that after Step e the Steps b to dare repeated in order to check the correction that was carried out.

9. The method according to claim 2 characterized in that after Step g, the Step b to f are repeated in order to check the correction that was carried out.

10. The method according to claim 1, characterized in that the detection device is moved together with the saw blade and the scoring blade.

11. The method according to claim 1, characterized in that by means of the saw blade, a sawed joint is produced, the sawed joint is detected by the detection device and the quality of the sawed joint, in particular at least one of the size, number of outliers, and the amplitude and frequency of a boundary wave, are evaluated.

12. A panel-sizing system for large-format panels the system comprising: a supporting table; a saw carriage that can be moved along a cutting line, said carriage having has a saw blade and scoring blade that is arranged at least approximately in the plane of the saw blade; a feed device for displacing a panel that lies on the supporting table; and an adjusting device by means of which the position of the scoring blade can be adjusted orthogonally to the blade level; the system characterized in that it includes a detection device for detecting the work result of scoring blade and saw blade and at least one of a control and regulating device that is programmed for use in a method according to claim 1.

13. The panel-sizing system according to claim 12, characterized in that the scoring blade is conical, at least regionally, and that its depth of immersion in the panel can be adjusted.

14. The panel-sizing system according to claim 12, characterized in that the detection device includes a camera.

15. The panel-sizing system according to claim 13, characterized in that the detection device comprises a laser scanning device.

16. The panel-sizing system according to claim 12, characterized in that the detection device comprises an ultrasound scanning device.

17. The panel-sizing system according to claim 12, characterized in that the detection device produces signals for a monitor on which the scoring groove and the sawed joint or joint can be visualized.

18. The panel-sizing system according to claims 12, characterized in that it includes a remote-controlled adjusting device for adjusting the scoring blade vertically to its plane.

19. The panel-sizing system according to claim 18, characterized in that the control and regulating device controls the adjusting device and in that way automatically corrects the position of the scoring blade.

20. The panel-sizing system according to claim 12, characterized in that at least one part of the detection device is arranged on its own movable carriage.

21. The panel-sizing system according to claim 12, characterized in that on the saw carriage, seen in the sawing direction, the detection device is arranged first, then the scoring blade, and then the saw blade.

22. The panel-sizing system according to claim 12, characterized in that it includes an evaluation system that assesses the quality of the sawed joint or joint, particularly at least one of the size, number of outliers, the amplitude, and the frequency of a boundary wave.
